(19) United States
(12) Patent Application Publication
(10) Pub. No.: US 2024/0261784 A1
(43) Pub. Date: Aug. 8, 2024

(54) MICROFLUIDIC CHIP

(71) Applicant: BEIJING MICVIC BIOTECH CO., LTD., Beijing (CN)

(72) Inventors: Li Songjing, Harbin (CN); Jun Han, Weihai (CN); Tao Ye, Tianjin (CN); Kui Tang, Shenzhen (CN)

(21) Appl. No.: 18/637,940

(22) Filed: Apr. 17, 2024

Related U.S. Application Data
(63) Continuation of application No. PCT/CN2022/108850, filed on Jul. 29, 2022.

(30) Foreign Application Priority Data
Oct. 19, 2021 (CN) 202111212492.7

(51) Int. Cl. B01L 3/00

(52) U.S. Cl. CPC B01L 3/50273; B01L 2200/025; B01L 2200/027; B01L 2300/0816; B01L 2300/0887; B01L 2400/0406

(57) ABSTRACT

The present invention proposes a microfluidic chip including a microchannel enclosed and formed by a substrate and a cover sheet, a sample fluid added into the microchannel through a sample adding well, a height of a top wall of said microchannel being lower than a height of a contact surface of the substrate and the cover sheet. Through the above setup, it can effectively prevent the leakage of liquid from the side of the microchannel, make the detection results more accurate, and reduce the invalid detection rate and scrap rate.

### CROSS-REFERENCE TO RELATED APPLICATION

The present application is a continuation of International Patent Application No. PCT/CN2022/108850, filed on Jul. 29, 2022, which claims the priority to and benefits of the Chinese Patent Application No. 202111212492.7, filed on Oct. 19, 2021 and titled “A MICROFLUIDIC CHIP”. All the aforementioned patent applications are hereby incorporated by reference in their entireties.

### TECHNICAL FIELD

The present invention relates to the field of in vitro diagnostic technology, and specifically relates to a microfluidic chip.

### BACKGROUND

Microfluidic chip is the main platform for the realization of microfluidic technology, which can integrate the sample preparation, reaction, separation, detection and other basic operating units of biological, chemical and medical analysis processes into a very small chip. The entire analytical process is automated through microchannels, for performing a variety of functions in a conventional chemical or biological laboratory. Microfluidic chip has the advantages of compact size, using small amounts of samples and reagents, fast reaction speed, enabling large number of parallel processes and being disposable, etc., which has great potential in the fields of biology, chemistry and medicine. In recent years, microfluidic chip has been developed into a brand-new research field in the cross-discipline of biology, chemistry, medicine, fluidics, electronics, materials and machinery, etc.

The current microfluidic chip generally uses a cover sheet with substrate(s) bonded to form a corresponding flow area and a reaction area, which places an extremely high requirement on sealing technology. If the bonding effect during sealing is not done well, there will be a problem of leaking liquid samples. At the same time, the microfluidic chip involves the detection of different disease markers, which may require different reaction times according to the detection needs for of the different samples. As for currently existing microfluidic chips, the reaction time of the sample in the microchannel is limited due to its inherent structural characteristics, which poses the problem of a narrower detection range when detecting certain disease markers.

### SUMMARY

It is the objective of the present invention to provide a microfluidic chip for solving the technical problems raised in the above background technology, in view of the deficiencies of the prior art.

In order to realize the above objective, the technical solution of the present invention is realized as follows, a microfluidic chip comprising a microchannel enclosed and formed by a substrate and a cover sheet, a sample fluid added into the microchannel through a sample adding well, the height of a top wall of said microchannel being lower than the height of a contact surface of the substrate and the cover sheet, and the sample fluid flowing towards an outlet of the microchannel under the capillary force of the microchannel.

Specifically, said microchannel is connected to the expansion channel via an upward connection channel.

Specifically, said microchannel is connected to the expansion channel via an inclined upward connection channel.

Specifically, a recess is provided along a lengthwise direction of the substrate, and a lower surface of the cover sheet projects toward the recess as a top wall of the microchannel, cooperating with the bottom wall of the recess to form the microchannel.

Specifically, said expansion channel extends in a direction parallel to the lengthwise direction of the microchannel; or said expansion holes/wells are spaced apart in a direction parallel to the length of the microchannel.

Specifically, said expansion hole is provided on one side of the microchannel side edge alone, or on both sides of the microchannel side edge at the same time.

Specifically, said microfluidic chip comprises a sample adding region and a liquid waste region connected to both ends of the microchannel, respectively, and said sample adding region is added with sample fluid and buffer through a sample adding well and a buffer adding well, respectively.

Specifically, said sample adding well is located between the buffer adding hole and the microchannel.

Specifically, said outlet of said microchannel is connected to a liquid waste region, said liquid waste region is connected to the outside world via a sample outlet, the sample outlet is embedded with an water-absorbent material that can be slid within the sample outlet, the sample outlet has at least two ends, one end is close to the outlet of the microchannel and the other end is away from the outlet of the microchannel.

Specifically, said expansion channel is enclosed by a recess provided on the cover sheet and the substrate; or enclosed by a recess provided on the substrate and the cover sheet; or said expansion hole is enclosed by a recess provided on the cover sheet and a recess provided on the substrate together.

A microfluidic chip obtained by the above technical solution has the beneficial effect of:
1. Effectively preventing liquid leakage at the sides of microchannel, so that the test results are more accurate, thereby reducing the invalid detection rate and scrap rate.
2. The inclined connection channel and expansion hole is conducive to gas exhausting, avoiding air bubbles from blocking the microchannel and making the liquid flow smoother.
3. With a dual-well setup of the sample adding well and buffer adding well, after the completion of the reaction in the microchannel, the buffer will push the reaction waste liquid to flow quickly to the liquid waste region, which reduces the reaction time of the entire microfluidic chip, and at the same time can rinse residual fluorescent solution left in the microchannel off, to avoid the interference of residual fluorescence on the detection results.
4. By setting a movable water-absorbent material at the sample outlet, when the fluid sample reacts in the microchannel, the water-absorbent material is disconnected from the microchannel, and the sample fluid will be retained in the microchannel, forming a liquid-phase reaction pool, which not only increases the reaction time, but also converts the dry-type fluorescence reaction into a liquid-phase fluorescence reaction, which greatly increases the adequacy of the reaction, and improves the precision of the detection results. When the reaction is completed, the water-absorbent material is moved so that the water-absorbent material is connected to the microchannel outlet, the waste liquid will be absorbed by the water-absorbent material into the waste liquid region, avoiding the waste liquid from affecting the detection results, the movement of the water-absorbent material can be controlled according to the type of reaction with the sample in the microchannel, this method in which reaction time is controllable can further improve the flexibility of the reaction time of different products, and at the same time, it can accelerate the reaction of the waste liquid to flow quickly to the waste liquid region, and the detection time can be shortened.

### BRIEF SUMMARY OF THE DRAWINGS

FIG. 1 is a cross-sectional view of one embodiment of the microfluidic chip described in the present invention.

FIG. 2 is a schematic diagram of the planar structure of the microfluidic chip described in the present invention.

FIG. 3 is a cross-sectional view of another embodiment of the microfluidic chip described in the present invention.

FIG. 4 is a cross-sectional view of a further embodiment of the microfluidic chip described in the present invention.

In the figures, substrate 1; cover sheet 2; microchannel 3; connection channel 4; expansion channel 5; sample adding region 6; liquid waste region 7; sample outlet 8; water-absorbent material 9; sample adding well 10; buffer adding well 11; fluorescent labeling region 3a; quality control region 3b; detection region 3c.

### DETAILED DESCRIPTION

It is noted that embodiments and features in embodiments in the present invention may be combined with each other without conflict.

In the description of the present invention, it is to be understood that the terms “center”, “longitudinal”, “lengthwise”, “transverse”, “up”, “down”, “front”, “back”, “left”, “right”, “vertical”, “horizontal”, “top”, “bottom”, “inside”, “outside”, etc. indicate orientations or positional relationships that are based on those shown in the accompanying drawings, and are intended only to facilitate the description of the invention and to simplify the description, and do not indicate or imply that the device or element referred to must have a particular orientation, be constructed and operated in a particular orientation, and therefore is not to be construed as a limitation of the present invention. Furthermore, the terms “first”, “second”, etc. are used only for descriptive purposes and are not to be construed as indicating or implying relative importance or implicitly specifying the number of technical features indicated. As a result, a feature defined as “first”, “second”, etc. may expressly or implicitly include one or more such features. In the description of the present invention, unless otherwise indicated, “plurality” means two or more.

In the description of the present invention, it is to be noted that, unless otherwise expressly specified and qualified, the terms “mounting”, “connecting”, “connecting”, “setup” are to be understood in a broad sense, e.g., as a fixed connection, a removable connection, or a connection in one piece; a mechanical connection or an electrical connection; a direct connection or an indirect connection through an intermediate medium; or a connection within two elements. To those ordinary skill in the art, the specific meaning of the above terms in the present invention may be understood by specific circumstances.

The present invention provides a microfluidic chip comprising a microchannel 3 having a defined height and width enclosed and formed by substrate 1 and a cover sheet 2, wherein a sample fluid can flow towards an outlet of the microchannel 3 under the capillary force of the microchannel 3, the microchannel 3 having a top wall, of which height is lower than a height of a contact surface of the substrate 1 and the cover sheet 2.

The present invention is described in detail below in connection with the embodiments and the accompanying drawings.

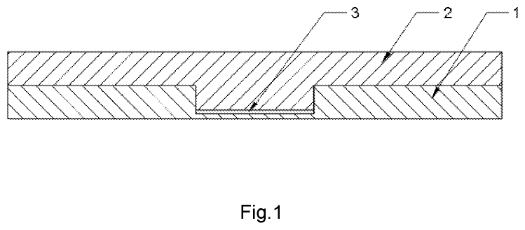

Shown in FIG. 1 is a cross-sectional view of a microfluidic chip of a first embodiment of the present invention, wherein the microchannel 3 is enclosed by the lower surface of the cover sheet 2 and the upper surface of the substrate 1, the substrate 1 is provided with a recess in a length direction of the substrate 1, and the lower surface of the cover sheet 2 is projected towards the recess as a top wall of the microchannel 3, which cooperates with the bottom wall of the recess to form the microchannel 3 for the sample fluid to pass through and undergo a reaction.

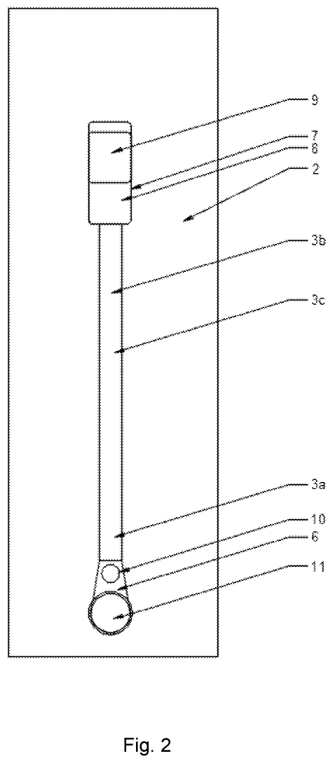

As shown in FIG. 2, the microchannel 3 is provided with a fluorescent labeling region 3a, a detection region 3c, and a quality control region 3b at sequential intervals along a direction of sample fluid flow.

The sample liquid is added into the chip from the inlet well, and then circulates in the direction of the outlet of the microchannel 3 under the capillary force of the microchannel 3. Since a height of a top wall of the microchannel 3 is lower than the height of the contact surface of the substrate 1 and the cover 2, as long as the amount of the added sample liquid is guaranteed, it is possible to effectively prevent leakage of liquid to the side of the microchannel 3, so as to make the detection results more accurate, reduce the invalid detection rate and the scrap rate, and at the same time, reduce the process requirements for microfluidic chip bonding.

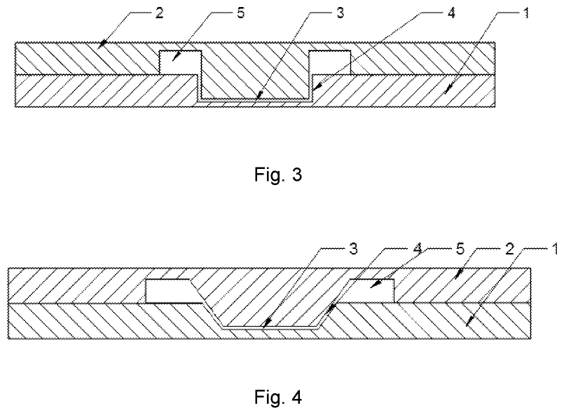

As shown in FIG. 3, the microfluidic chip also includes expansion channel 5, the microchannel 3 is connected to the expansion channel 5 through an upwardly directed connection channel 4, the height of the expansion channel 5 is higher than the height of the microchannel 3, the expansion channel 5 is enclosed by the recess provided on the cover sheet 2 and the substrate 1; or enclosed by the recess provided on the substrate and the cover sheet; or enclosed by the recess provided on the cover sheet and the recess provided on the substrate together.

The extension holes/wells 5 are provided to reduce air bubbles during the flow of the sample fluid, and the extension holes/wells 5 can be provided either on one side of the microchannel 3 sideways alone or at both sides of the microchannel 3 sideways at the same time; they can be provided either at intervals along the length of the microchannel 3 or continuously provided.

Another preferred embodiment of the present invention is shown in FIG. 4, unlike FIG. 3, the projection on the cover 2 and the recess on the substrate 1 forming the microchannel 3 are trapezoidal in cross-section, i.e., the expansion channel 5 is connected to the expansion hole 5 by means of the upwardly inclined connection channel 4, and air bubbles generated during the flow of the sample fluid can be better discharged.

As shown in FIG. 2, the chip in the above embodiment further comprises a sample adding region 6 and a liquid waste region 7, which are connected to both ends of the microchannel 3 respectively, and the heights of the sample adding region 6 and the liquid waste region are the same as the height of the microchannel 3, and the sample adding region 6 is added with sample fluid and buffer through a sample adding hole 10 and a buffer adding well 11 provided on the top surface of the cover sheet 2, wherein the sample adding well 10 is located between the buffer adding well 11 and the microchannel 3, and the sample adding region 6 has a width greater than a width of the microchannel 3, and the sample adding region 6 and the microchannel 3 are connected by a curved connecting section with a gradually tightening width.

After the sample fluid reaction is completed, buffer is added to the buffer adding well, and the buffer pushes the waste liquid of reaction to flow rapidly to the waste liquid region 7, which can flush the residual fluorescent solution in the microchannel 3 after the reaction, avoiding the residual liquid in the microchannel 3 from interfering with the detection results, and at the same time reducing the overall time of the whole microchip detection operation to meet the market demand for POCT immediate detection and faster reaction time.

The liquid waste region 7 is connected to the outside world through a sample outlet 8 provided on the substrate 1, and the sample outlet 8 is embedded with a water-absorbent material 9 slidable within the sample outlet 8. The sample outlet 8 has at least two ends, one end is close to the outlet of the microchannel 3 and the other end is away from the outlet of the microchannel 3, so as to enable the water-absorbent material 9 to be connected to the outlet of the microchannel 3 and to be away from the outlet of the microchannel 3, respectively.

The water-absorbent material 9 may be made of polyester fiber, water-absorbent resin, water-absorbent gelatin, papermaking wood pulp, or other materials with water-absorbent characteristics, and the specifications of the water-absorbent material 9 may be adjusted in accordance with the amount of the sample to be detected to be added to the chip, and the water-absorbent ability of the water-absorbent material 9 is maintained as a whole to be at least 2-4 times the amount of the sample to be detected to be added, in order to prevent the water-absorbent material 9 from becoming saturated and thus causing the sample to be detected to leak from the sample outlet 8.

Before adding the sample, make sure that the water-absorbent material 9 is located at the end of the sample outlet 8 away from the microchannel 3, after adding a quantitative amount of sample fluid to the sample adding hole 10, the sample fluid flows into the microchannel 3 from the sample adding area and moves toward the outlet of the microchannel 3 under capillary action, at this time, there is no connection of the water-absorbent material 9, and the sample fluid stagnates inside the microchannel 3 to carry out a sufficient reaction. After the reaction is complete, the water-absorbent material 9 is mechanically made to slid to connect with the outlet of the microchannel 3, the water-absorbent material 9 is in contact with the sample fluid, to absorb the sample fluid flowing into the waste liquid region 7 completely, and cooperate with optical analyzer to detect.

D-dimer (D-Dimer) is mainly used in the detection of thrombotic diseases, and the following is a comparative experiment between the microfluidic chip in the second embodiment of the present invention and the existing microfluidic chip by quantitatively detecting the D-dimer content in plasma and whole blood as an example.

### 1. Material Preparation

The improved D-dimer (D-Dimer) microfluidic chip a and the non-improved D-dimer (D-Dimer) microfluidic chip b (compared with microfluidic chip b whose water-absorbent material is fixed and non-movable in the waste liquid region, the liquid waste region of microfluidic chip a is connected with outside world through sample outlet, in which water-absorbent material is embedded in sample outlet in a slidable way), both produced by Shandong MicVic Biotech Co., Ltd;

D-dimer (D-Dimer) clinical samples S1 and S2, were obtained from the relevant hospitals;

Fluorescence Immunoassay Analyzer, Timer (e.g., stopwatch) and Pipette from Shandong Mic Vic Biotech Co., Ltd.

### 2. Coating Sites

Coating site II is located in detection region 3c and is coated with D-Dimer antibody.

Coating site IV is located in quality control region 3b and is coated with secondary antibody;

Fluorescent labeling region 3a is immobilized with dried D-Dimer fluorescent labeled paired antibody.

### 3. Detection Methods

### 3.1 Improved D-Dimer (D-Dimer) Microfluidic Chip

The improved D-dimer (D-Dimer) microfluidic chip a was placed flat on the experimental bench, and the water-absorbent material 9 was disconnected from the microchannel 3 before adding samples. The samples were added into sample adding hole 10 of the microfluidic chip, and after timing for 2 minutes, the water-absorbent material 9 was moved in the opposite direction to connect with the microchannel 3, and 15 μL of buffer was added into the buffer adding hole 11, and after 3 min, the chip was read by fluorescence immunoassay analyzer, and the detection results of D-Dimer samples were recorded. Samples S1 and S2 were measured in parallel, and each sample was repeated five times. The relative deviation of the mean value of each sample from the original concentration value was calculated, and the coefficient of variation (CV) of each sample was calculated.

### 3.2 Non-Improved D-Dimer (D-Dimer) Microfluidic Chip

The non-improved D-dimer (D-Dimer) microfluidic chip was placed flat on the experimental bench, and the samples were added into the microfluidic chip, and after 5 min, the chip was read by fluorescence immunoassay analyzer, and the detection results of D-Dimer samples were recorded. Samples S1 and S2 were measured in parallel, and each sample was repeated five times. The relative deviation of the mean value of each sample from the original concentration value was calculated, and the coefficient of variation (CV) of each sample was calculated.

### 4. Results

As shown in Table 1, the relative deviations of the detection results of the improved D-Dimer microfluidic chip from the original concentration values were no more than ±5%, and the CVs were all less than 5%, while the relative deviations of the detection results of the non-improved D-Dimer microfluidic chip from the original concentration values were no more than ±10%, and the CVs were all less than 10%, and the deviations and CVs of the improved microfluidic chip were smaller than those of the non-improved microfluidic chip, which indicated that the improved microfluidic chip detection results were more accurate and more homogeneous. As can be seen from the detection point signal values, the improved fluorescence signal values are higher than the non-improved fluorescence signal values, indicating a more adequate reaction;

TABLE 1
Sample detection results before and after microfluidic chip improvement

| | Original | Chip a (improved) | | | | |
|---|---|---|---|---|---|---|
| | concentration | | Detection | | | |
| | value | Coating | concentration | Mean value | Relative | |
| Sample | (ng/mL) | site II | (ng/mL) | (ng/mL) | deviation | CV |
| S1 | 500.1 | 24229 | 484.6 | 515.1 | 3.01% | 3.52% |
| | | 26650 | 532.7 | | | |
| | | 25954 | 518.9 | | | |
| | | 25853 | 516.9 | | | |
| | | 26146 | 522.7 | | | |
| S2 | 2012.5 | 102466 | 2039.6 | 2094.4 | 4.07% | 3.27% |
| | | 103314 | 2056.5 | | | |
| | | 108172 | 2153.1 | | | |
| | | 102472 | 2039.8 | | | |
| | | 109681 | 2183.1 | | | |
| | Original | Chip b (non-improved) | | | | |
| | concentration | | Detection | | | |
| | values | Coating | concentration | Mean value | Relative | |
| Sample | (ng/mL) | site II | (ng/mL) | (ng/mL) | deviation | CV |
| S1 | 500.1 | 13990 | 522.1 | 456.2 | −8.78% | 9.63% |
| | | 11988 | 447.8 | | | |
| | | 12398 | 463.0 | | | |
| | | 10689 | 399.6 | | | |
| | | 12008 | 448.5 | | | |
| S2 | 2012.5 | 44626 | 1658.7 | 1812.4 | −9.94% | 9.07% |
| | | 45804 | 1702.4 | | | |
| | | 53249 | 1978.7 | | | |
| | | 53892 | 2002.5 | | | |
| | | 46262 | 1719.4 | | | |

The above technical solutions only reflect the preferred technical solutions of the technical solutions of the present invention, and some changes that may be made to some parts of the technical field of the technical staff reflect the principles of the present invention, and are within the scope of protection of the present invention.

What is claimed is:

1. A microfluidic chip comprising a microchannel enclosed and formed by a substrate and a cover sheet, the microchannel is added with a sample fluid through a sample adding well, characterized in that a height of a top wall of said microchannel is lower than a height of a contact surface of the substrate and the cover sheet, and the sample fluid flows towards an outlet of the microchannel under the capillary force of the microchannel, wherein an outlet of said microchannel is connected to the liquid waste region, said liquid waste region is connected to the outside world via a sample outlet, the sample outlet is embedded with a water-absorbent material that can be slid within the sample outlet, the sample outlet has at least two ends, one end being close to the outlet of the microchannel. and the other end being away from the outlet of the microchannel.

2. The microfluidic chip according to claim 1, characterized in that said microchannel is connected to expansion channel via an upward connection channel.

3. The microfluidic chip according to claim 1, characterized in that said microchannel is connected to expansion channel via an inclined upward connection channel.

4. The microfluidic chip according to claim 1, characterized in that a recess is provided along a length direction of the substrate, and the lower surface of the cover sheet projects towards the recess as a top wall of the microchannel, cooperating with the bottom wall of the recess to form the microchannel.

5. The microfluidic chip according to claim 2, characterized in that said expansion channel extends in a direction parallel to the length of the microchannel; or said expansion channels are spaced apart in a direction parallel to the length of the microchannel.

6. The microfluidic chip according to claim 2, characterized in that said expansion channel is provided on one side of the microchannel side edges alone, or on both sides of the microchannel side edges at the same time.

7. The microfluidic chip according to claim 1, characterized in that said microfluidic chip comprises a sample adding region and a liquid waste region connected to the both ends of the microchannel, respectively, and said sample adding region is added with sample fluid and buffer through a sample adding well and a buffer adding well, respectively.

8. The microfluidic chip according to claim 6, characterized in that said sample adding well is located between the buffer adding well and the microchannel.

9. The microfluidic chip according to claim 2, characterized in that said expansion channel is enclosed by a recess provided on the cover sheet and the substrate; or enclosed by a recess provided on the substrate and the cover sheet; or said expansion channel is enclosed by a recess provided on the cover sheet and a recess provided on the substrate together.
